(19) United States
(12) Patent Application Publication
(10) Pub. No.: US 2011/0041126 A1
(43) Pub. Date: Feb. 17, 2011

(54) MANAGING WORKLOADS IN A VIRTUAL COMPUTING ENVIRONMENT

(76) Inventors: Roger P. Levy, Somerset, NJ (US); Jeffrey M. Jaffe, Brookline, MA (US); Kattiganehalli Y. Srinivasan, Princeton Junction, NJ (US); Matthew T. Richards, Sudbury, MA (US); Robert A. Wipfel, Draper, UT (US)

Correspondence Address: KING & SCHICKLI, PLLC, 247 NORTH BROADWAY, LEXINGTON, KY, 40507, US

(21) Appl. No.: 12/540,650

(22) Filed: Aug. 13, 2009

(51) Int. Cl. G06F 9/455

(52) U.S. Cl. 718/1

(57) ABSTRACT

Methods and apparatus involve continuous management of workloads, including regular monitoring, profiling, tuning and fault analysis by way of instrumentation in the workloads themselves. Broadly, features contemplate collecting current state information from remote or local workloads and correlating it to predefined operational characteristics to see if such defines an acceptable operating state. If so, operation continues. If not, remediation action occurs. In a virtual environment with workloads performing under the scheduling control of a hypervisor, state information may also come from a hypervisor as well as any guest user and kernel spaces of an attendant operating system. Executable instructions in the form of probes gather this information from items of the stack available for control and deliver it to the management system. Other features contemplate supporting/auditing third party cloud computing services, validating service level agreements, and consulting independent software vendors. Security, computing systems and computer program products are other embodiments.

### FIELD OF THE INVENTION

Generally, the present invention relates to computing devices and environments involving computing workloads. Particularly, although not exclusively, it relates to managing on-site and off-premise workloads including monitoring, profiling, tuning, fault analysis, etc. Managing also occurs during times of migration from on- to off-site premises. Instrumentation injected into the workload, as well as guest user and kernel spaces and the hypervisor, interfaces with the requisite management systems. This also results in software and virtual appliances having tight correlation to its attendant operating system. Certain embodiments contemplate management in “cloud” computing environments. Other features contemplate billing support and auditing for third party cloud computing services, validating service level agreements, and consulting independent software vendors, to name a few. Security, computing systems and computer program products are still other embodiments.

### BACKGROUND OF THE INVENTION

“Cloud computing” is fast becoming a viable computing model for both small and large enterprises. The “cloud” typifies a computing style in which dynamically scalable and often virtualized resources are provided as a service over the Internet. The term itself is a metaphor. As is known, the cloud infrastructure permits treating computing resources as utilities automatically provisioned on demand while the cost of service is strictly based on the actual resource consumption. Consumers of the resource also leverage technologies from the cloud that might not otherwise be available to them, in house, absent the cloud environment. “Vitualization” in the cloud is also emerging as a preferred paradigm whereby workloads are hosted on any appropriate hardware.

While much of the industry moves toward the paradigm, very little discussion exists concerning managing or controlling the workloads and its storage. In other words, once workloads are deployed beyond the boundaries of the data center, their lack of visibility causes a lack of oversight. Also, management and controlling workloads locally deployed in a home data center lacks sufficient oversight. In some instances, this is due to poor correlation between the workloads, the operating system and hypervisor, which may be exceptionally diverse as provided by unrelated third parties.

Accordingly, a need exists for better managing on- and off-premise workloads, as well as those in migration. The need should further extend to better correlation between the workloads, applications, operating systems, hypervisors, etc., despite a lack of universal ownership thereof. Even more, management is contemplated with minimal intrusion in its support. Naturally, any improvements along such lines should contemplate good engineering practices, such as simplicity, ease of implementation, unobtrusiveness, stability, etc.

### SUMMARY OF THE INVENTION

The foregoing and other problems become solved by applying the principles and teachings associated with managing workloads in a virtual computing environment. Broadly, methods and apparatus involve continuous management of workloads, including regular monitoring, profiling, tuning and fault analysis by way of instrumentation injected into the workloads, operating system (guest user and kernel spaces) and hypervisor relative to a management interface. To the extent each or any of the items of the stack (e.g., application, guest user and kernel spaces, and hypervisor) are not commonly owned, controlled or otherwise accessible, the instrumentation will nonetheless exist in those items that remain available and operational metrics in the unavailable items can be deduced from lower operating levels. The foregoing is especially convenient in situations where workloads are deployed in “cloud” computing environments while home, data centers retain repository data and command and control over the workloads.

In one embodiment, current state information is collected from the workloads where it is correlated locally to predefined operational characteristics to see if such defines an acceptable operating state. If so, operation continues. If not, remediation or other action is taken. In an environment with workloads performing under the scheduling control of a hypervisor, state information may also come from the hypervisor as well as any guest user and kernel spaces of an attendant operating system. Executable instructions in the form of probes gather this information and deliver it back to the management interface, which may exist locally or remotely in an enterprise data center.

Ultimately, a framework is provided for obtaining management information and providing tuning recommendations. The framework even includes consultation with independent software vendors (ISV) so they can provide higher quality of service. Still other features contemplate supporting and auditing third party cloud computing services and validating service level agreements. Certain advantages include: (a) introspection at the application level, guest OS level and the hypervisor level (for data collection); (b) monitoring and managing the operations stack (workload, kernel space, user space, and hypervisor) for health and operational information; (c) remediation based on intelligence (trace driven or policy driven etc.) to determine appropriate corrective actions and timing, including locations or “hooks” in the workload stack to accept the directives; and (d) various use cases for the collected data: performance management, fault management, global (data center wide) resource management, billing, auditing, capacity management etc.

In practicing the foregoing, at least first and second computing devices have a hardware platform. The platform includes a processor, memory and available storage upon which a plurality of workloads can be configured under the scheduling control of a hypervisor including at least one operating system with guest user and kernel spaces. Executable instructions configured as “probes” on one of the hardware platforms collects current state information from a respective workload, hypervisor and guest user and kernel spaces and to returns it to another of the hardware platforms back at the enterprise. Upon receipt, it is correlated to predefined operational characteristics for the workloads to determine whether such are satisfactorily operating. If not, a variety of remediation events are described.

Executable instructions loaded on one or more computing devices for undertaking the foregoing are also contemplated as are computer program products available as a download or on a computer readable medium. The computer program products are also available for installation on a network appliance or an individual computing device.

These and other embodiments of the present invention will be set forth in the description which follows, and in part will become apparent to those of ordinary skill in the art by reference to the following description of the invention and referenced drawings or by practice of the invention. The claims, however, indicate the particularities of the invention.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagrammatic view in accordance with the present invention of a basic computing device for hosting workloads;

FIG. 2 is a combined flow chart and diagrammatic view in accordance with the present invention for managing workloads in a virtual environment; and

FIG. 3 is a diagrammatic view in accordance with the present invention of a cloud and data center environment for workloads.

### DETAILED DESCRIPTION OF THE ILLUSTRATED EMBODIMENTS

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, arrangement, software and/or other changes may be made without departing from the scope of the present invention. In accordance with the present invention, methods and apparatus are hereinafter described for managing workloads in a virtual computing environment.

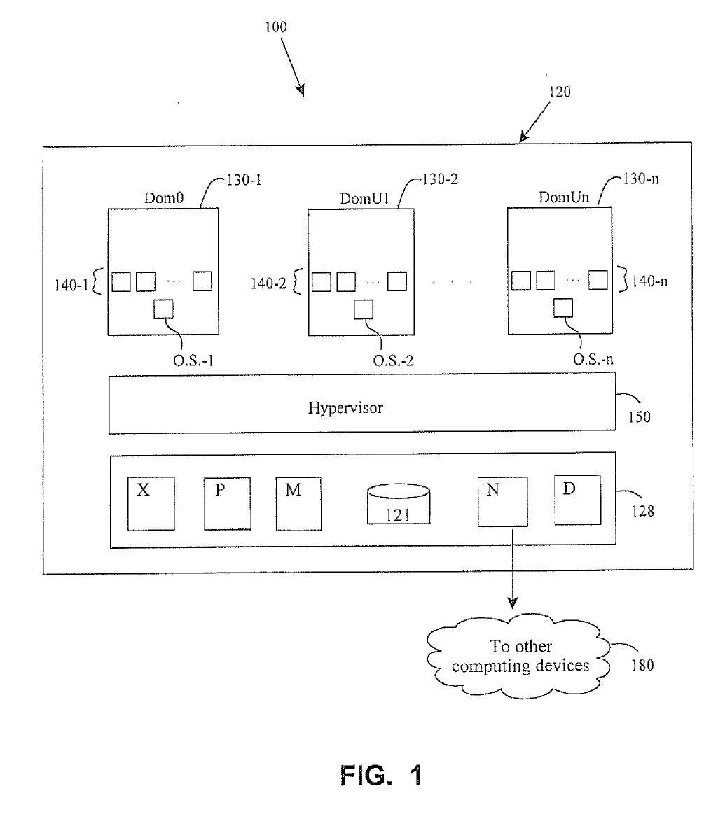

With reference to FIG. 1, a computing system environment 100 for hosting workloads includes a computing device 120. Representatively, the device is a general or special purpose computer, a phone, a PDA, a server, a laptop, etc., having a hardware platform 128. The hardware platform includes physical I/O and platform devices, memory (M), processor (P), such as a CPU(s), USB or other interfaces (X), drivers (D), etc. In turn, the hardware platform hosts one or more virtual machines in the form of domains 130-1 (domain 0, or management domain), 130-2 (domain U1), . . . 130-n (domain Un), each having its own guest operating system (O.S.) (e.g., Linux, Windows, Netware, Unix, etc.), applications 140-1, 140-2, . . . 140-n, file systems, etc. The workloads (e.g., application and middleware) of each virtual machine also consume data stored on one or more disks 121.

An intervening Xen or other hypervisor layer 150, also known as a “virtual machine monitor,” or virtualization manager, serves as a virtual interface to the hardware and virtualizes the hardware. It is also the lowest and most privileged layer and performs scheduling control between the virtual machines as they task the resources of the hardware platform, e.g., memory, processor, storage, network (N) (by way of network interface cards, for example), etc. The hypervisor also manages conflicts, among other things, caused by operating system access to privileged machine instructions. The hypervisor can also be type 1 (native) or type 2 (hosted). According to various partitions, the operating systems, applications, application data, boot data, or other data, executable instructions, etc., of the machines are virtually stored on the resources of the hardware platform.

In use, the representative computing device 120 is arranged to communicate 180 with one or more other computing devices or networks. In this regard, the devices may use wired, wireless or combined connections to other devices/networks and may be direct or indirect connections. If direct, they typify connections within physical or network proximity (e.g., intranet). If indirect, they typify connections such as those found with the internet, satellites, radio transmissions, or the like. The connections may also be local area networks (LAN), wide area networks (WAN), metro area networks (MAN), etc., that are presented by way of example and not limitation. The topology is also any of a variety, such as ring, star, bridged, cascaded, meshed, or other known or hereinafter invented arrangement.

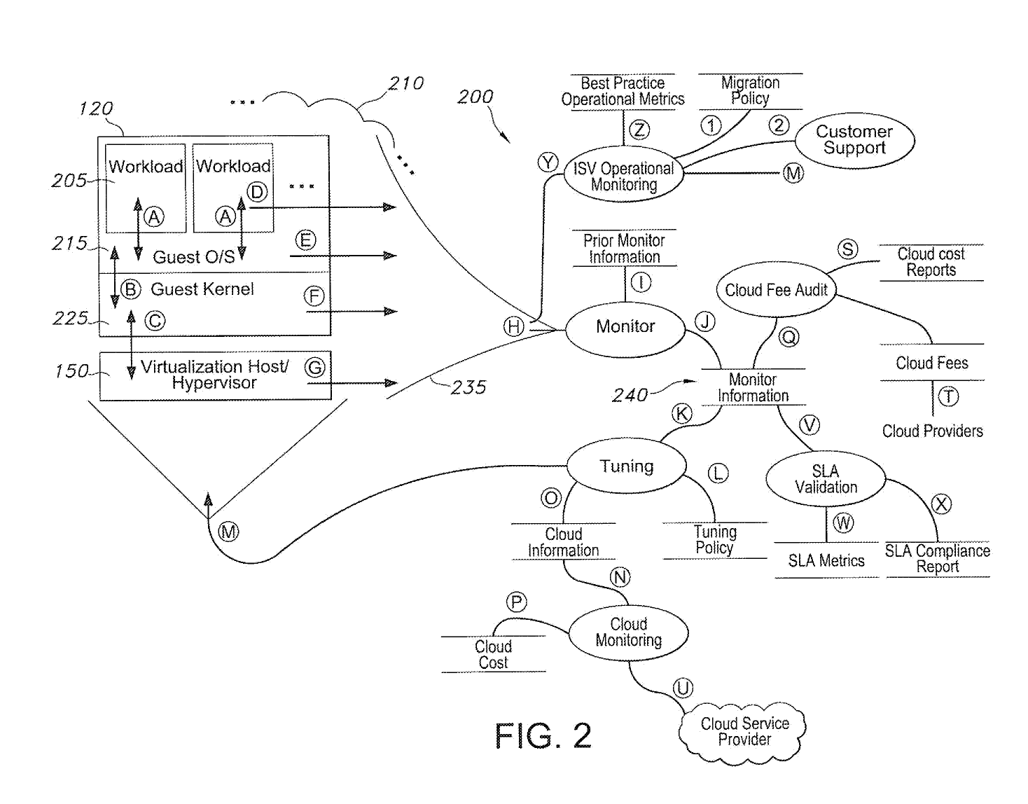

Leveraging the foregoing, FIG. 2 shows a flow and diagram 200 for managing the workloads of a computing device 120. Representatively, this includes management of the workloads deployed at a location, such as a cloud 210. In the past, the workloads would not have instrumentation to a management interface, but now such is available for an enterprise undertaking events such as monitoring, profiling, tuning, fault analysis, or the like.

### EXAMPLE

In an embodiment, the invention proceeds as follows:

The invention provides for a workload 205 that resides in either user space 215 or kernel space 225 of the guest operating system. In this regard, it is known in the art to have communication between the workload and the guest operating system at item A, communication between the user space and kernel space as shown at item B, and communication between the kernel and the hypervisor 150 at item C. The communication exists in a variety of computing instructions found on the hardware platform.

Unknown heretofore, however, is that each of the workload, user and kernel space and the hypervisor may be instrumented with executable code acting as probes at items D, E, F and G. During use, these probes gather or collect activity information about the current state of operations for the workload, guest OS, hypervisor, etc. and communicate it back to one or more computing devices at the enterprise 235 where it is analyzed or otherwise interpreted. The use of known computing agents are also contemplated as are retrofits to existing products, such as SUSE Linux, SUSE JEOS, etc. (To the extent each or any of the items of the workload, application, guest user and kernel spaces, hypervisor, etc., are not commonly owned, controlled or otherwise accessible for instrumentation, the instrumentation will nonetheless exist in those items that remain available. For example, the assignee of the current invention, Novell, Inc. has access to its Suse Linux operating system and can instrument it according to desire. Novell, Inc., on the other hand, may not have access to Microsoft, Inc.'s, Windows operating system and cannot fully instrument it. Thus, lower operating levels available to Novell, such as the hypervisor layer, will then deduce metrics in the unavailable operating system item. It does so, for instance, by examining various scheduling items flowing through the hypervisor.) Also, the times for gathering information from the stack and communicating it back can be substantially continuous and/or discrete, including periodic intervals, random times, when needed, at selected times, etc. The methods for communicating can be varied as well, including wired, wireless, combinations, or other.

At item H, the information provided by the probes at items D, E, F, and G, are collected at a computing device having a monitor process. In turn, the monitor process is executable code serving as an intake that gathers, arranges and prioritizes the arriving information. It may also serve to decide what is the next appropriate action, such as whether an audit, fault analysis, software patching, etc., is required, and selves to channel information to the next processing branch. In this regard, the monitor process has access to prior monitor information via item I. In an embodiment, this may include stores of data mapped to acceptable thresholds or policies that become correlated by the monitor to the information being received at item H concerning the current state of the operations stack (i.e., the hypervisor, kernel space, user space, and workload). Once correlated and analyzed, the results may also be housed in a storage facility, such as the monitor information repository 240 for later use during a next instance of correlation and analysis. Ultimately, the information the monitor information repository provides at 240 is both raw operational characteristics and summarized operational characteristics as well as fault analysis, fault profiling, etc. such that the total state of the operations stack can be characterized at any instant in time and between instances in time. It is then available for use by the tuning, cloud fee audit and SLA validation functions via items K, Q, and V, respectively.

As an example, current state information about a workload may be a fault analysis in the form of a page fault rate of X. Upon receipt by the monitor process at item H, checking the prior monitor information at item I might reveal an acceptable minimum page fault rate of Y. If X<Y, corrective action is then required via tuning at item K, that occurs thereafter, to get X above or equal to Y. Similarly, current state information might be indicated in numbers of packets dropped by a receiving buffer and if such is too high, a corrective course of action might include allocating more memory. Alternatively still, current state information might indicate an occurrence of an event. Upon checking the prior monitor information, it might reveal that the event has already occurred two previous times, thus making the current event the third time in sequence. Remediation may then dictate taking action upon the third instance. Other contemplated courses of action include, but are not limited to, collecting and remediating items associated with performance data, error data, diagnostics information, fault signatures, performance characteristics and profiles, and fault analysis. Of course, skilled artisans can contemplate other scenarios.

In addition, the tuning mechanism at item K is also able to access a tuning policy at item L to provide tuning recommendations to the operations stack at item M to restore the stack to an acceptable operational state when required. In this regard, the tuning policy repository contains policy statements formulated by data center and enterprise management personnel that describe the actions that should be taken given the correlation of certain events obtained from the operations stack. The tuning policy may be temporally constrained such that policy resolution is different from time to time thus allowing for scenarios such as follow-the-sun. Alternatively, the policies can be established at an enterprise level, division level, individual level, etc. It can include setting forth the computing situations in which tuning events are optionally or absolutely required. Further still, policies may specify when and how long tuning events will take place. This can include establishing the time for tuning, setting forth an expiration or renewal date, or the like. Policies may also include defining a quality of service for either the operations stack and hardware platform requirements, such as device type, speed, storage, etc. These policies can also exist as part of a policy engine that communicates with other engines, such as a workload deployment engine (not shown). Skilled artisans can readily imagine other scenarios.

At item O, the tuning may also consult cloud information to monitor the cloud at item N wherein the information concerning the cloud operational characteristics and cloud costs matrices are found at item P. In this manner, costs and statistics can be inserted via N into cloud information repository such that the tuning module can take such into account via item O. As an example, the cloud 210 may make available a given quantity of memory to a workload per a cost of $A. To the extent the remediation event at item M to expand memory to cure the earlier identified problem of dropped packets will not exceed the cost identified as $A, the tuning functionality can immediately add the memory for the workload's use. On the other hand, if the extra memory will add costs above the identified $A, then the tuning functionality may delay adding memory until a later time when other costs are lower, such that the overall cloud bill will not increase above a predetermined threshold. Naturally, other scenarios are possible here too and this should be considered a non-limiting example.

At item V, another embodiment having access to the monitoring information 240 is the service level agreement (SLA) validation function. In detail, it has access to SLA metrics at item W which define the expected metrics that should be obtained from an SLA with a third party and can be used to produce an SLA compliance (or non-compliance) report via item X. As an illustration, an SLA may specify a quality-of-service contract term as a page fault rate of less than 1000/(unit of time) at item W. To the extent current information obtained via item H reveals a page fault rate of more than 1000/(unit of time), correlation to the metric at item W reveals non-compliance and a report is generated at item X and provided to the parties of the agreement. Also, acts of remediation may occur via the tuning function to lower the fault rate simultaneously with the report of non-compliance, such that upon a next evaluation of the SLA, the parties have complied with its terms.

Similarly, another embodiment having access to the monitoring information 240 is the cloud fee audit mechanism at item Q. By accessing published/negotiated cloud fees at item R, obtained from cloud providers at item T, it can be determined whether current fees charged for off premise or cloud assets correctly comply with actual cloud cost reports at item S. For instance, a cloud fee on a financial bill at item R from a cloud provider at item T may state that so much CPU usage in a month is $B. Upon collecting data at item H from the workloads, it can be determined how much actual CPU usage occurred for the month and such can be stored in the repository 240. Then, upon receipt of an actual bill of $C for CPU usage at item S front the cloud provider, the audit function can determine whether $C complies with the actual usage of the workload and whether any discrepancies exist with the reported fees of $B/usage per month.

As another example, the cloud fee audit mechanism could be used to support billing practices of the cloud provider. In this regard, collected data at item H from the workloads might reveal how much actual CPU usage occurred for the month. This information could then be provided to the cloud provider so they can generate an appropriate bill to a client reflecting the usage, and doing so in accordance with published/negotiated cloud fees at item R. Of course, other scenarios are readily imagined here.

At item Y, skilled artisans will appreciate that third party vendors (or independent software vendors (ISVs)) may be involved in the products used in the computing device 120. As such, they too may want or need the information collected at item H. Thus, the ISV operational monitoring function receives information at item Y which is used to provide a third party management mechanism for the infrastructure operating the operational stack. In such a case, the ISV is interested in making sure that the infrastructure or services being provided to the enterprise are operating correctly and perhaps according to some SLA (which may be simultaneously audited/validated at item V). To do this, the ISV operational monitoring function accesses its best practice operational metrics via item Z and, combines them with mitigation policies at item 1 to either provide tuning recommendations at item M or trouble ticket type information to customer support mechanisms (self help menus, call centers/desks, etc.) via item 2.

In any embodiment, the communications from item D, E, F, and G to items H and Y together with communications back at item M can all be secured, if necessary (e.g., SSL, VPN or some cryptographic mechanism). Compression of data may also be useful during communications to save transmission bandwidth. For all, well known or future algorithms and techniques can be used.

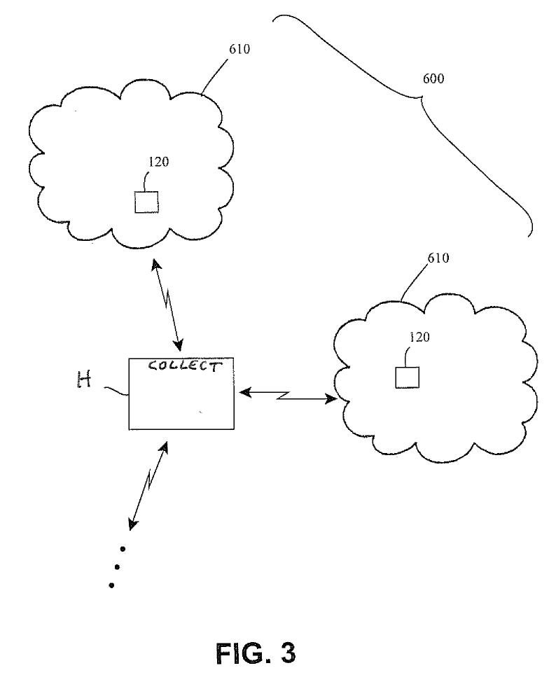

With reference to FIG. 3, the features of the invention can be replicated many times over in a larger computing environment 600, such as a large enterprise environment. For instance, multiple data centers or multiple clouds 610 could exist that are each connected by way of a common collection mechanism item H, for each of the probes a D, E, F, and G for computing devices 120. Alternatively, each data center or cloud could include a collection mechanism at item H. Also, the computing policies, tuning, validation, auditing, etc. could be centrally managed and could further include scaling to account for competing interests between the individual data centers 610. Other policies could also exist that harmonize the events of the data centers. Nested hierarchies of all could further exist.

Ultimately, skilled artisans should recognize at least the following advantages. Namely, they should appreciate that the foregoing supports bidirectional communication channels between the management operations platform and on or off-site or transiting monitored workloads including real-time, near real-time, and batch communications contain information concerning: 1) performance data; 2) error data; 3) diagnostics information; 4) fault signatures; 5) tuning recommendations; 6) performance characteristics and profiles; 7) fault analysis; and 8) predictive fault analysis, to name a few.

In still other embodiments, skilled artisans will appreciate that enterprises can implement some or all of the foregoing with humans, such as system administrators, computing devices, executable code, or combinations thereof. In turn, methods and apparatus of the invention further contemplate computer executable instructions, e.g., code or software, as part of computer program products on readable media, e.g., disks for insertion in a drive of computing device, or available as downloads or direct use from an upstream computing device. When described in the context of such computer program products, it is denoted that items thereof, such as modules, routines, programs, objects, components, data structures, etc., perform particular tasks or implement particular abstract data types within various structures of the computing system which cause a certain function or group of function, and such are well known in the art. These computer program products may also install or retrofit the requisite executable code to items D, E, F and G in an existing operations stack.

The foregoing has been described in terms of specific embodiments, but one of ordinary skill in the art will recognize that additional embodiments are possible without departing from its teachings. This detailed description, therefore, and particularly the specific details of the exemplary embodiments disclosed, is given primarily for clarity of understanding, and no unnecessary limitations are to be implied. Modifications will become evident to those skilled in the art upon reading this disclosure and may be made without departing from the spirit or scope of the invention. Relatively apparent modifications, of course, include combining the various features of one or more figures with the features of one or more of the other figures.

1. In a computing system environment, a method of managing workloads deployed as virtual machines under the scheduling control of hypervisors on computing devices having hardware platforms with at least one operating system with guest user and kernel spaces, comprising:
collecting current state information from each of the workloads, hypervisors and guest user and kernel spaces; and
correlating the current state information to predefined operational characteristics for the workloads, hypervisors and guest user and kernel spaces.

2. The method of claim 1, further including determining if any remediation action is required for any of the workloads, hypervisors and guest user and kernel spaces based on the correlating.

3. The method of claim 2, if the remediation action is said required, further including restoring one of the workloads, hypervisors and guest user and kernel spaces to an acceptable operational state.

4. The method of claim 1, further including fulfilling an audit request of a computing cloud in which the workloads are deployed.

5. The method of claim 4, further including comparing usage of the hardware or software platforms to a financial bill from the computing cloud for any discrepancies.

6. The method of claim 1, further including validating contract terms of a service level agreement.

7. The method of claim 1, further including inserting probes of executable instructions onto the hardware platforms to said collect current state information from said each of the workloads, hypervisors and guest user and kernel spaces.

8. The method of claim 1, further including prioritizing the collected current state information.

9. The method of claim 1, further including storing the collected current state information for later use as earlier collected state information during the correlating to the predefined operational characteristics.

10. In a computing system environment, a method of managing workloads deployed as virtual machines under the scheduling control of hypervisors on computing devices having hardware platforms with at least one operating system with guest user and kernel spaces, comprising:
deploying the workloads for use on the hardware platforms at a location remote or local to an enterprise;
collecting current state information from each of the workloads, hypervisors and guest user and kernel spaces;
providing the collected current state information to a computing device located at the enterprise; and
at the computing device at the enterprise, correlating the current state information to predefined operational characteristics for the workloads, hypervisors and guest user and kernel spaces.

11. The method of claim 10, further including determining if any remediation action is required for any of the workloads, hypervisors and guest user and kernel spaces based on the correlating and if the remediation action is said required, further including restoring one of the workloads, hypervisors and guest user and kernel spaces to an acceptable operational state.

12. The method of claim 11, wherein the determining if any remediation action is required further includes conducting fault analysis of the workloads, hypervisors and guest user and kernel spaces by comparing to stored fault signatures.

13. The method of claim 11, wherein the determining if any remediation action is required further includes consulting stored policy statements established by the enterprise.

14. The method of claim 11, wherein the determining if any remediation action is required further includes consulting an independent software vendor at still another location remote from the enterprise in order to establish the acceptable operational state of the workloads, hypervisors and guest user and kernel spaces.

15. The method of claim 10, further including fulfilling an audit request of a computing cloud in which the workloads are deployed at the location remote from the enterprise.

16. The method of claim 15, further including identifying usage of the hardware or software platforms to generate a financial bill from the computing cloud or to identify any discrepancies.

17. The method of claim 10, further including inserting probes of executable instructions into the hardware platforms to said collect current state information from said each of the workloads, hypervisors and guest user and kernel spaces.

18. A computing system to manage workloads deployed as victual machines under the scheduling control of hypervisors on computing devices having hardware platforms with at least one operating system with guest user and kernel spaces, comprising:
at least first and second computing devices having a hardware platform with a processor, memory and available storage upon which a plurality of workloads can be configured under the scheduling control of a hypervisor including at least one operating system with guest user and kernel spaces;
probes of executable instructions configured on one of the hardware platforms to said collect current state information from a respective said workload, hypervisor and guest user and kernel spaces and to return the collected current state information to another of the hardware platforms; and
correlating executable instructions configured on the another of the hardware platforms to correlate the current state information to predefined operational characteristics for the workloads, hypervisors and guest user and kernel spaces, the predefined operation characteristics residing on the available storage for the another of the hardware platforms.

19. The computing system of claim 18, further including executable instructions configured on the another hardware platform that can be delivered to the one of the hardware platforms to restore one of the workload, hypervisor and guest user and kernel spaces to an acceptable operational state in situations requiring remediation therefor.

20. The computing system of claim 18, further including executable instructions configured on the another hardware platform that can generate or audit for discrepancies in a financial bill of a computing cloud in which the one of the hardware platforms is deployed.
